(19) United States
(12) Patent Application Publication
(10) Pub. No.: US 2020/0406414 A1
(43) Pub. Date: Dec. 31, 2020

(54) SYSTEM AND METHOD FOR AUTOMATIC LOADING AND UNLOADING OF JOBS IN CNC MACHINES

(71) Applicant: Siddhant Sarup, Ludhiana, Punjab (IN)

(72) Inventors: Gaurav Sarup, Ludhiana, Punjab (IN); Siddhant Sarup, Ludhiana, Punjab (IN); Prashant Sarup, Ludhiana, Punjab (IN)

(21) Appl. No.: 16/971,681

(22) PCT Filed: Oct. 30, 2018
(86) PCT No.: PCT/IN2018/050698

§ 371 Date: Aug. 20, 2020

(30) Foreign Application Priority Data
Feb. 24, 2018 (IN) 201811007024

(51) Int. Cl. B23Q 7/04; B23Q 7/00; B23Q 7/08

(52) U.S. Cl. CPC B23Q 7/048; B23Q 7/003; B23Q 2707/003; B23Q 7/005; B23Q 7/08

(57) ABSTRACT

The automatic loading and unloading system for CNC machines of the present invention makes use of cross slide component of the CNC machine itself and its sliding movements to perform loading and unloading a finished job from machine, and eliminating need of external robots/gantry. The system comprises a set of twin grippers placed at the cross slide, first gripper and second gripper. The twin grippers perform the load, unload and eject operations in two actions: firstly, the first gripper picks up new job from pickup zone, while the second gripper unloads finished job from chuck simultaneously; and secondly, the first gripper loads the new job into chuck, while the second gripper drops the finished job into an ejector chute from where the finished job comes out of the machine simultaneously.

### FIELD OF THE INVENTION

The present invention is generally related to CNC machines. More particularly, the present invention is related to a method and system for automatic loading and unloading of jobs in a CNC machine.

### BACKGROUND OF THE INVENTION

CNC machines are widely used for manufacturing parts or components, since these machines automate the manufacturing process by implementing computer generated design and directives. The machines need raw jobs to be loaded and finished jobs to be unloaded from them to continue the process without any interruptions. Conventional methods for loading and unloading involve human operators for some CNC machines; while others involve robot or gantry systems for automate the loading and unloading process. Having human operators for loading systems are considered inefficient and also dangerous.

While present auto loading systems, which include robotic systems or gantry arms, are external to the machines and require an access for the robots to enter the machine enclosures for loading and unloading of jobs. Such accesses are, generally, doors positioned either in front or top of the machine and they open and close to allow the entry of robots or gantry arms. A usual way of loading system includes a robot unloading a finished job, loading a new job, coming out of the door and dropping the finished job at a designated point.

Such existing auto loading methods and systems use complex CNC controlled machines (Robot or Gantry), which are generally expensive and require a machine door to open every time a job needs to be unloaded and a raw job needs to be loaded in the machine. This is, in turn, a time and energy consuming method and also allows escape of a coolant mist when the door opens. This escaped coolant mist is a loss of money and also spreads dampness in the area around machine.

Therefore, there exists a need for auto loading and unloading systems in the CNC machines which is simpler, faster and efficient, and does not allow the coolant mist to escape, hence helps in saving money.

### SUMMARY OF THE INVENTION

Hence, it is an objective of the present invention to provide an innovative and efficient way of unloading machined jobs, loading new jobs and removing machined jobs from the CNC machines.

It is an objective of the present invention to provide an auto loading system and method for CNC machines that ensures entry of new jobs into machine enclosures and exit of finished jobs from the enclosure through small cavities/openings which eliminate necessity of having a door and its opening.

It is another objective of the present invention to provide an auto loading system and method for CNC machines that exploits the CNC machine's cross slide movements only, to eliminate need for external machines like Robot or Gantry for loading & unloading, making the design of the system simpler.

It is a yet another objective of the present invention to design an auto loading system which eliminates opening of doors of the CNC machines and hence, does not allow the coolant mist to escape from the machine enclosure.

### BRIEF DESCRIPTION OF DRAWINGS

For a better understanding of the embodiments of the systems and methods described herein, and to show more clearly how they may be carried into effect, references will now be made, by way of example, to the accompanying drawings, wherein like reference numerals represent like elements/components throughout and wherein:

FIG. 1 illustrates an exemplary environment showing a CNC machine employed with an auto loading and unloading system, in accordance with an embodiment of the present invention;

FIGS. 2 and 3 illustrate a first and a second grippers of the CNC machine performing job handling operations i.e. unload, load and eject a machined job, in accordance with an embodiment of the present invention;

FIG. 4 illustrates a block diagram of the exemplary environment shown in FIGS. 1, 2, and 3 of the CNC machine employing the auto loading and unloading system of the present invention, in accordance with an embodiment of the present invention; and

FIG. 5 illustrates a flow chart showing a method for auto loading and unloading jobs from the CNC machine, in accordance with an embodiment of the present invention.

### DETAILED DESCRIPTION OF THE INVENTION

This patent describes the subject matter for patenting with specificity to meet statutory requirements. However, the description itself is not intended to limit the scope of this patent. The principles described herein may be embodied in many different forms.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The present invention provides an automatic loading and unloading system and method to be employed in CNC machines. For the purposes of clarity and simplicity, in the further description, the ‘automatic loading and unloading system and method’ of the present invention is referred to as ‘auto loading system’, without deviating from the meaning and scope of the present invention. The auto loading system uses the slide component of the CNC machine itself and exploits its sliding movements to perform four job handling operations, which are pick a raw job, unload the machined job, load the raw job and eject the machined job from a CNC machine enclosure. Using the sliding movements of the CNC machine itself, eliminates the need of having any external robotic/gantry arm. The system, further, comprises twin preset grippers.

The auto load system uses the twin grippers on the cross slide of the CNC machines to complete the above four job handling operations in only TWO actions; first simultaneously pick a new job from a pickup zone AND unload a finished job from a chuck of a spindle; and second, load the new job in the chuck and drop the finished job in a chute. This offers a simple and faster way of auto loading and unloading jobs from the CNC machines. It may be apparent to a person skilled in that the auto loading system may use a variety of suitable job handling tools, including the twin grippers, depending on the design and requirement of the CNC machine, without deviating from the meaning and scope of the present invention. It may also be apparent to a person skilled in the art that the present auto loading system may be applied to a variety of CNC machines, such as Lather, Milling, and others.

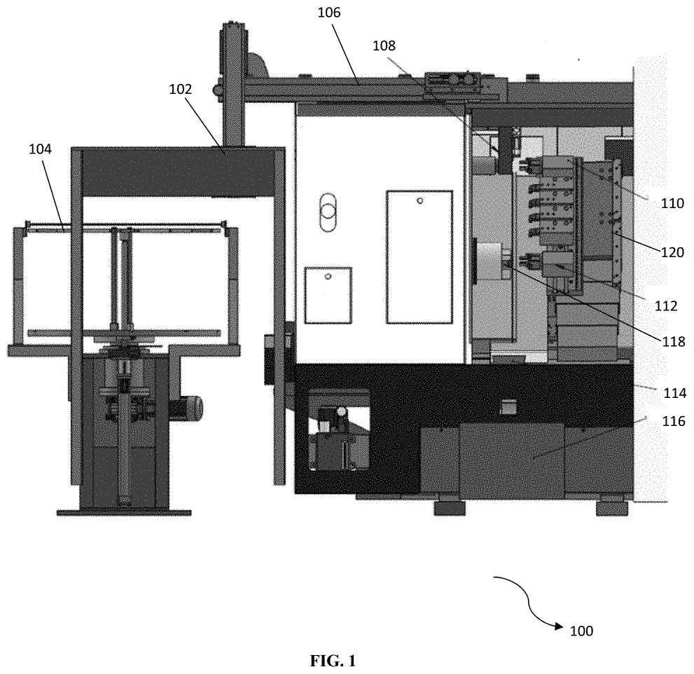

FIG. 1 illustrates an exemplary environment showing a CNC machine employed with the present auto loading and unloading system, in accordance with an environment of the present invention. The CNC machine 100 includes a gantry arm 102 for picking up raw jobs to be loaded in the CNC machine 100; a stacker (or any other suitable infeed device like Bowlfeeder) 104 on which the raw jobs are stacked to be picked up by the gantry arm 102; an in-feed conveyer 106 that feeds the raw jobs into the machine 100; a machine chute 108 for conveying the jobs to a pickup zone inside the CNC machine 100 to be picked for being worked upon; a set of twin grippers including a first gripper 110 and a second gripper 112 for gripping or holding the jobs while in the machine 100; and an ejector chute 114 from which the finished job is ejected out from the machine towards an out-feed bin 116. The grippers 110 and 112 are installed at the top end and bottom end of a Cross Slide (X Axis) 120 respectively. Their movement of picking up jobs from pickup zone and chuck simultaneously is controlled by a Slide movement which is controlled by the CNC.

In a preferred embodiment as shown in the FIG. 1, the CNC machine is a single spindle machine with one chuck for turning, and with one set of twin grippers to load raw jobs and unload finished jobs. In operation, the gantry arm 102 picks up a raw job from the stacker (or any other suitable infeed device like Bowlfeeder) 104 and place it on the in-feed conveyer 106. The in-feed conveyer 106, further, feeds the raw job towards the machine chute 108. In turn, the first chute 108 supplies the raw job to the pickup zone from where it is picked by the first gripper 110. The machine 100 has a set twin of grippers 110 and 112 working and performing the job handling operations of load, unload and eject. The CNC machine 100 has a spindle with a chuck 118 attached to it, from where the finished jobs are unloaded simultaneously, of the raw jobs being picked up from the pickup zone.

In an embodiment, the CNC machine may be a double spindle machine having two spindles with two chucks. In such cases, the CNC machine will have two chutes leading to two chucks, and with two sets of twin grippers working together to load and unload jobs from the machine. Both the chucks work at the same time as raw jobs are being fed to them simultaneously.

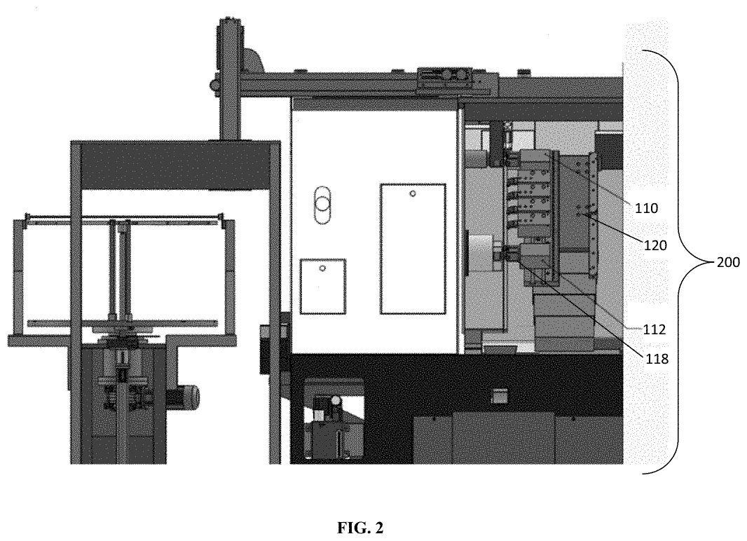

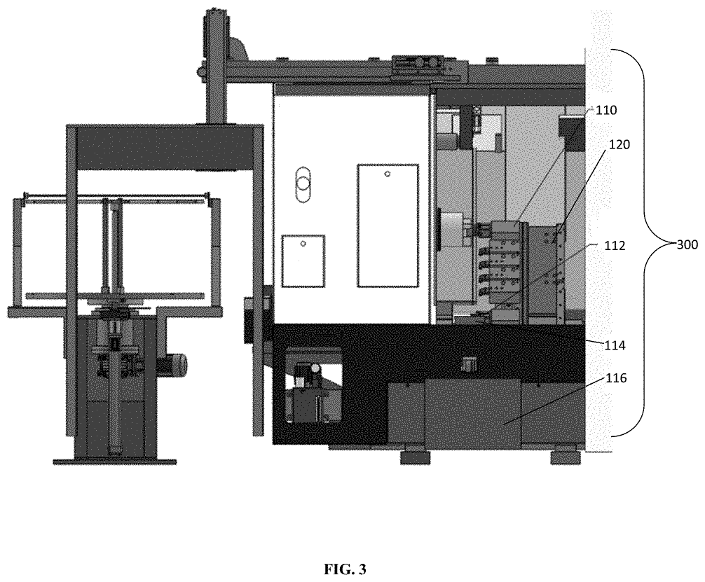

FIGS. 2 and 3 illustrate the first and second grippers of the CNC machine performing job handling operations i.e. unload, load and eject a machined/finished job, in accordance with an embodiment of the present invention. FIG. 2 illustrates a first position 200 of the two grippers 110 and 112 on the Cross Slide. In the position 200, the first gripper 110 clamps the raw job from the pickup zone in the chute 108 of the CNC machine; while simultaneously, the second gripper 112 unloads a finished job from the chuck 118.

Thereafter, as shown in FIG. 3, a second position 300 of the two grippers 110 and 112 on the Cross Slide. The grippers 110 and 112 slide from the position 200 to position 300 on the Cross Slide now, where the first gripper 110 loads the raw job into the chuck 118; while simultaneously the second gripper 112 puts the finished job into the ejector chute 114. Consequently, the finished job slides through the ejector chute 114 and lands into the out-feed bin 116 after it comes out from the ejector chute 114.

In the embodiment wherein the CNC machine is a double spindle machine, each spindle has a set of first and second grippers, where each set employed in the CNC machine works in the same fashion as described in the above FIGS. 2 and 3. Both the chucks work at the same time while they are being fed with the raw jobs simultaneously. It may be appreciated by a person skilled in the art that the present invention may also work in the same way with multi-spindle CNC machines, more than two spindles, where each spindle has a set of twin grippers performing the job handling operations, without departing from the meaning and scope of the present invention.

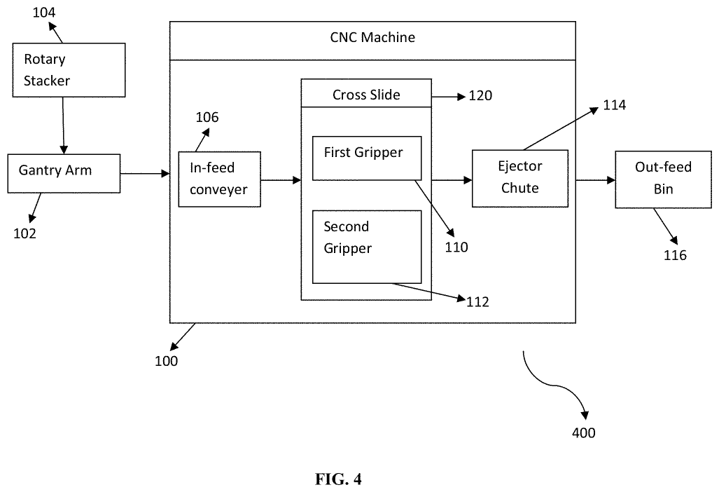

FIG. 4 illustrates a block diagram of the exemplary environment shown in FIGS. 1, 2, and 3 of the CNC machine employing the auto loading system of the present invention, in accordance with an embodiment of the present invention. The block diagram 400 shows the CNC machine 100 communicating with the gantry arm 102 that picks up one or more raw jobs from the stacker (or any other suitable infeed device like Bowlfeeder) 104 and drops them on the in-feed conveyer 106 of the CNC machine 100. The present innovative auto loading system implemented in the CNC machine 100 exploits the sliding movements of the Cross Slide of the machine 100 itself to load the raw jobs from the pickup zone to the chuck and unload the finished jobs from the chuck to the out-feed bin outside the CNC machine 100. The auto loading system comprises twin preset grippers, the first gripper 110 and the second gripper 112. As the gantry arm 102 drops the raw jobs on the in-feed conveyer 106, it conveys the raw jobs to the chute 108 of the machine 100. It may be appreciated by a person skilled in the art that the machine 100 may have more than one chute and one spindle depending on the nature of the CNC machine. In an embodiment, the CNC machine 100 may have two spindles.

Further, the raw job is taken to the pick-up zone from where it is picked up by the first gripper 110, while simultaneously the second gripper 112 unloads a finished job from the chuck 118 of the CNC machine 100, when the first and the second grippers 110 and 112 are in the position 200 shown above in FIG. 2. Thereafter, the two grippers 110 and 112 slide to the second position 300 on the Cross Slide, and the first gripper 110 loads the raw job on the chuck, while the second gripper 112 unloads and drops the finished job in the ejector chute 114 simultaneously. The ejector chute 114 takes the finished job into the out-feed bin 116 for collection.

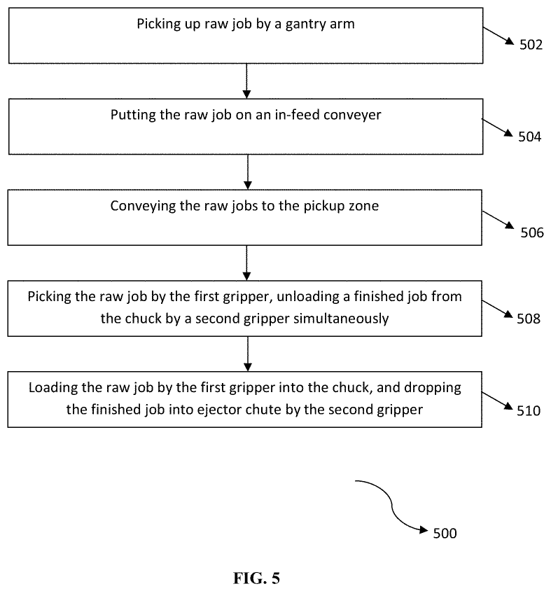

FIG. 5 illustrates a flow chart showing a method for auto loading and unloading jobs from the CNC machine, in accordance with an embodiment of the present invention. The flowchart 500 shows the step 502, at which the gantry arm 102 picks up one or more raw jobs from the stacker (or any other suitable infeed device like Bowlfeeder) 104. At step 504, the gantry arm 102 drops the raw job on the in-feed conveyer 106 of the CNC machine 100. At step 506, the in-feed conveyer 106 conveys the raw job to pickup zone in the machine chute 108. In an embodiment, the CNC machine 100 may have two machine chutes and two spindles.

For a single spindle CNC machine 100, a set of twin grippers is used: the first and the second grippers (110 and 112) which are placed on the Cross Slide of the CNC machine and their sliding movements together are controlled by the CNC. At step 508, the raw job reaches the pick-up zone, where it is picked up by the first gripper 110, while simultaneously the second gripper 112 unloads a finished job from the chuck of the CNC machine 100. The step 508 executes when the first and the second grippers 110 and 112 are positioned at the position 200 on the Cross Slide. Thereafter, the first and the second grippers 110 and 112 slide to the position 300 from the position 200 on the Cross Slide. Being at the position 300, the first gripper 110 loads the raw job on the chuck, while the second gripper 112 unloads and drops the finished job in the ejector chute 114 simultaneously, at step 510. The finished job slides through the ejector chute 114 and is dropped into the out-feed bin 116 for collection.

Advantageously, the present invention provides an auto loading system which is simpler in design and functions faster than the conventional systems. It eliminates the need for external machines like Robot or Gantry for loading & unloading, since the present auto loading system uses the Cross Slide component of the CNC machine itself. The slide components facilitate the movement of the first and the second grippers along X-axis for loading and unloading the jobs, simultaneously, in the CNC machine. Further, the CNC machine using the present auto loading system do not have any doors for allowing the entry of robots/gantry arms, which in turn eliminates the need for door opening. Hence, the CNC machine prevents the coolant mist to be escaped from the machine enclosure. Therefore, the present invention saves space due to its simple design; saves in cost since it prevents escape of coolant mist and also eliminates use of external robots/gantry arms and complex CNC controlling parts; is easy to set-up and has low operational cost over lifetime. The auto loading system works preferably for loading and unloading of small mass produced jobs like Rings, Gear Blanks & Valves/Pins. It, further, eliminates need for human loading and unloading which is a repetitive job.

While certain embodiments have been described, these embodiments have been presented by way of example only, and are not intended to limit the scope of the present disclosure. Indeed, the novel methods, devices, and systems described herein may be embodied in a variety of other forms. Furthermore, various omissions, substitutions, and changes in the form of the methods, devices, and systems described herein may be made without departing from the spirit of the present disclosure.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed.

Also, those acts that are not dependent on other acts may be performed in parallel with the other acts. The scope of embodiments is by no means limited by these specific examples.

Numerous variations, whether explicitly given in the specification or not, such as differences in structure, dimension, and use of material, are possible. Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

I claim:

1. An automatic loading and unloading system for a CNC machine comprising:
a set of twin grippers, including a first gripper and a second gripper, the first gripper is installed at top and the second gripper is installed at bottom of a cross slide (X Axis) of the CNC machine;
the set of twin grippers hold and move jobs within and outside the CNC machine, by following below steps:
the cross slide maintains the set of twin grippers at a first position where the first gripper clamps a raw job from a pickup zone located above a chuck of the CNC machine, while the second gripper clamps and unloads a finished job from the chuck of the CNC machine, simultaneously; and
the cross slide moves and slides the set of twin grippers to a second position where the first gripper loads the raw job into the chuck of the CNC machine, while the second gripper puts the finished job into an ejector chute of the CNC machine, simultaneously.

2. The system as claimed in claim 1, wherein the finished job slides through the ejector chute and lands into an out-feed bin from where the finished job is collected out from the CNC machine.

3. The system as claimed in claim 1 also includes a stacker (or any other suitable infeed device like Bowlfeeder) for stacking raw jobs; a gantry arm for picking up raw job from the rotary stacker and place it on an in-feed conveyer; and the in-feed conveyer, further, feeds the raw job towards a machine chute that supplies the raw job to the pickup zone from where it is picked by the first gripper.

4. The system as claimed in claim 1, wherein the movement of the set of twin grippers across the CNC machine is controlled by the cross slide (X axis) which is further controlled by the CNC controller.

5. The system as claimed in claim 1, wherein the CNC machine is a single spindle machine, and may be one of a variety of CNC machines, such as Lather, Milling, and others.

6. A method of automatic loading and unloading jobs in a CNC machine comprising:
maintaining a cross slide of the CNC machine at a first position of a twin set of grippers, including a first gripper and a second gripper;
clamping and picking a raw job from a pickup zone by the first gripper, while unloading a finished job from a chuck of the CNC machine by the second gripper, simultaneously;
moving the cross slide that slides the twin set of grippers to a second position; and
loading the raw job into the chuck of the CNC machine by the first gripper, while putting the finished job into an ejector chute of the CNC machine by the second gripper, simultaneously; and
where the first gripper is installed at the top and the second gripper is installed at the bottom of the cross slide.

7. The method as claimed in claim 6 further includes the finished job sliding through the ejector chute and landing into an out-feed bin from where the finished job is collected out from the CNC machine.

8. The method as claimed in claim 6 also includes stacking raw jobs on a stacker for; picking up raw job from the rotary stacker by a gantry arm for and placing it on an in-feed conveyer; and feeding the raw job towards a machine chute from the in-feed conveyer that supplies the raw job to the pickup zone from where it is picked by the first gripper.

9. The method as claimed in claim 6, wherein the movement of the set twin of grippers between the first and the second positions is controlled by the cross slide (X axis) which is further controlled by the CNC controller.

10. The method as claimed in claim 6, wherein the pickup zone is located above the chuck of the CNC machine.

11. The method as claimed in claim 6, wherein the CNC machine is a single spindle machine, and may be one of a variety of CNC machines, such as Lathe, Milling, and others
